(19) United States
(12) Patent Application Publication
(10) Pub. No.: US 2026/0095381 A1
(43) Pub. Date: Apr. 2, 2026

(54) RATING ACCURACY OF ANALYTICS IN A WIRELESS COMMUNICATION NETWORK

(71) Applicant: Lenovo (Singapore) Pte. LTD, Singapore (SG)

(72) Inventors: Dimitrios Karampatsis, Ruislip (GB); Konstantinos Samdanis, Munich (DE)

(73) Assignee: Lenovo (Singapore) Pte. Limited, Singapore (SG)

(21) Appl. No.: 19/112,704

(22) PCT Filed: Dec. 6, 2022
(86) PCT No.: PCT/EP2022/084516

§ 371 Date: Mar. 18, 2025

(30) Foreign Application Priority Data
Nov. 1, 2022 (GR) 20220100881

(51) Int. Cl. H04L 41/14; H04L 41/16

(52) U.S. Cl. CPC H04L 41/145; H04L 41/16

(57) ABSTRACT

Accordingly, there is provided a data analytics function comprising a receiver and a processor. The receiver is arranged to receive analytics feedback information in respective of particular analytics from an analytics consumer. The processor is arranged to: identify affected network functions based on the analytics feedback information; determine if the affected network functions are used as data sources for the particular analytics; rate the network functions as data sources by comparing a prediction with source data; and determine the accuracy of the particular analytics based on the rating of the network functions used as a source of data for the particular analytics.

### FIELD

The subject matter disclosed herein relates generally to the field of implementing a rating accuracy of analytics in a wireless communication network. This document defines a data analytics function and a method in a data analytics function.

### BACKGROUND

In 3GPP, data analytics services are provided by the Network Data Analytics Function (NWDAF) (see 3GPP TS 23.288 v17.5.0) and aim to support network data analytics services in the 5G Core network. Such analytics can collect data from other Network Functions (NFs), or Application Function (AF) or Operations and Maintenance (OAM) and can be exposed to a third party and/or AF to provide statistics and predictions related to the operation of the wireless communication network. Such statistics and predictions may relate to slice Load level, observed Service experience, NF Load, Network Performance, UE related analytics (mobility, communication), User data congestion, Quality of Service (QoS) sustainability, Data Network (DN) performance, etc. Moreover, in 3GPP SA5 (3GPP TS 28.533 v17.2.0), management data analytics service (MDAS) provides data analytics for the network. MDAS can be deployed at different levels, for example, at domain level (e.g. Radio Access Network (RAN), Core Network (CN), network slice subnet) or in a centralized manner (e.g. in a Public Land Mobile Network (PLMN) level). The objective of MDAS is to optimize the management plane (in network/domain level, in slice/slice subnet level) by performing analytics based on network management data. Such service can be exposed to the third party/MDAS service consumer to provide PM analytics, FM Analytics, Network Slice instance (NSI)/Network Slice Subnet Instance (NSSI) analytics, optionally recommend appropriate management actions e.g., scaling of resources, admission control, load balancing of traffic, etc. An additional analytics function in 3GPP is discussed in 3GPP SA6 (3GPP TR 23.700-36 v0.4.0) where an application data analytics enablement service (ADAES) is defined for performing app layer and edge/cloud analytics outside 3GPP domain.

In 3GPP TR 23.700-81 v0.3.0 (titled: Study on Enablers for Network Automation for 5G-phase 3), one key issue that is discussed is Key Issue #1: How to improve correctness of NWDAF analytics. Correctness of predictions is usually associated to accuracy, which represents the most prominent Key Performance Indicators (KPI) to rate Machine Learning (ML) models. However, the accuracy can be corrupted by a drift related to a mismatch between training data and inference data. It is thus of utmost importance to ensure accuracy. Incorrect predictions can be due to the fact that the accuracy of an ML model during inference may be lower than the accuracy of the same ML model during training.

### SUMMARY

A data analytics function as defined herein tends to provide improved analytics data. This is done by facilitating the rating of data sources used in the analytics. The improved data analytics tend to be provided as a result of a rating of data sources used for analytics. The rating can be used as a criterion for selecting from which sources to collect data, thus improving the quality of the analytics service.

Disclosed herein are procedures for rating accuracy of analytics in a wireless communication network. Said procedures may be implemented by a data analytics function and a method in a data analytics function.

Accordingly, there is provided a data analytics function comprising a receiver and a processor. The receiver is arranged to receive analytics feedback information in respective of particular analytics from an analytics consumer. The processor is arranged to: identify affected network functions based on the analytics feedback information; determine if the affected network functions are used as data sources for the particular analytics; rate the network functions as data sources by comparing a prediction with source data; and determine the accuracy of the particular analytics based on the rating of the network functions used as a source of data for the particular analytics.

There is further provided a method in a data analytics function. The method comprises: receiving analytics feedback information in respective of particular analytics, the analytics feedback information received from an analytics consumer; and identifying affected network functions based on the analytics feedback information. The method further comprises: determining if the affected network functions are used as data sources for the particular analytics; rating the network functions as data sources by comparing a prediction with source data; and determining the accuracy of the particular analytics based on the rating of the network functions used as a source of data for the particular analytics.

Rating the network functions as defined herein allows a data analytics function to accommodate changes in the wireless communication network, and so compensate for the ‘model drift’ that is found to adversely affect analytics accuracy over time. Further, such a data analytics function may identify data sources affected by erroneous or unstable AnLF analytics and limit their effect on future analytics output by controlling their impact on AnLF(s) and MTLF(s). Such control may be facilitated by rating the data sources used by the erroneous or unstable AnLF analytics.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for rating accuracy of analytics in a wireless communication network will now be described, by way of example only, with reference to the accompanying drawings, in which:

FIG. 1 depicts an embodiment of a wireless communication system for rating accuracy of analytics in a wireless communication network;

FIG. 2 depicts a user equipment apparatus that may be used for implementing the methods described herein;

FIG. 3 depicts further details of the network node that may be used for implementing the methods described herein;

FIG. 4 illustrates an example wireless communication system;

FIG. 5 illustrates the architecture of a wireless communication system;

FIG. 6 illustrates a method that may be performed by a data analytics function as described herein;

FIG. 7 illustrates a procedure for informing other potentially affected AnLF(s) that operate in the same area as data analytics function; and

FIG. 8 illustrates a method in a data analytics function.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

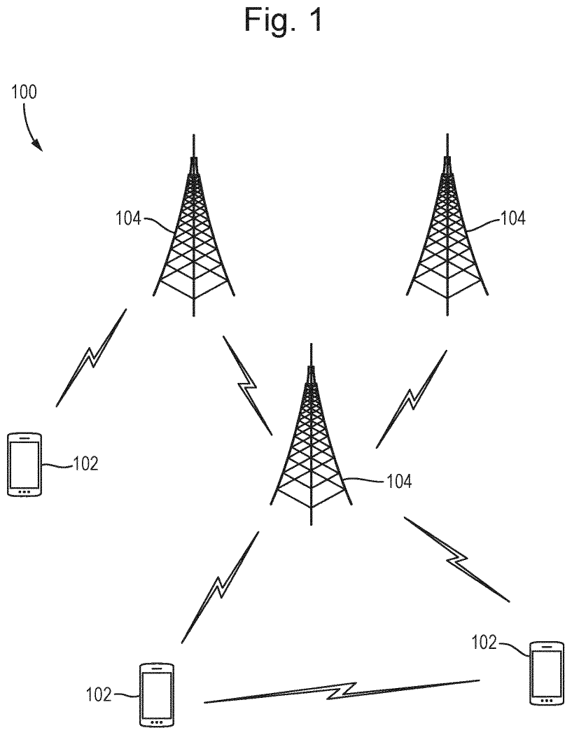

FIG. 1 depicts an embodiment of a wireless communication system 100 for rating accuracy of analytics in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

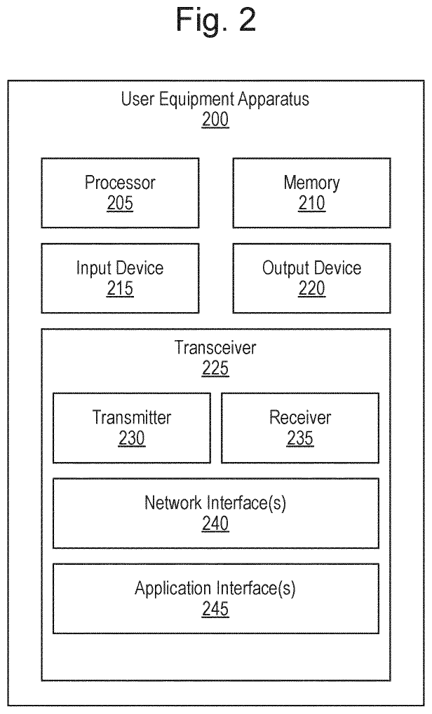

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102 or a UE 404 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

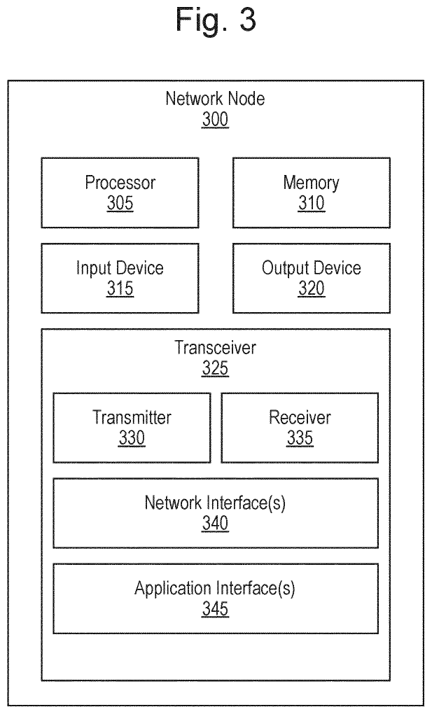

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a data analytics function, an NWDAF 550, 650, or an AnLF NWDAF 410, 750 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

When a consumer requests analytics from an NWDAF, the consumer may include in the request a target area and/or target object(s) (e.g., a network function “NF”) and/or a target UE or group of UE(s). The NWDAF derives analytics by collecting data and/or events from one or more Network Functions ensuring the data are from the target area requested or involve the target UE(s). The analytics are derived taking into account a “snapshot” of the location of UEs based on AMF determining a UE entering or leaving a specific area of interest with a granularity of Tracking Area(s) or Cell ID(s).

In the current Release 16 and Release 17 3GPP architecture the NWDAF (defined in 3GPP TS 23.288 v17.2.0) provides analytic output to one or more Analytics Consumer NFs or AFs or OAM based on Data Collected from one or more Data Producer NFs and/or AFs and/or OAM.

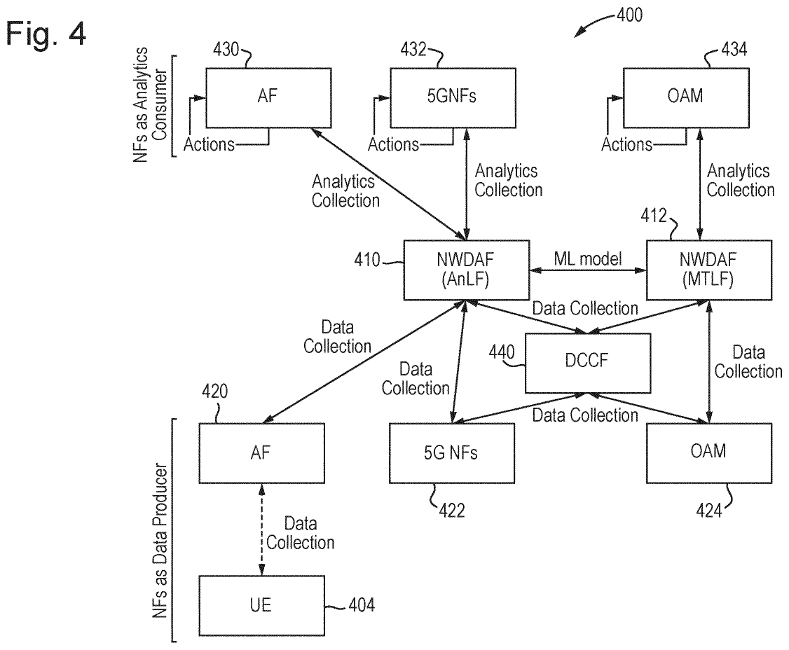

FIG. 4 illustrates an example wireless communication system 400. The system 100 comprises an NWDAF Analytics Logical Functions (ANLF) 410, a an NWDAF Model Training Logical Function (MTLF) 412, a plurality of Data Producer Network Functions, in this example am Application Function (AF) 420, a 5G Network Function 422, and an Operations, Administration and Maintenance (OAM) 424. The wireless communication system 400 further comprises a Data Collection Co-ordination Function (DCCF) 440 and a plurality of Analytics Consumer Network Functions which in this example include an Application Function 430, a 5G Network Function 432, and an OAM 434. In the current Release 16 and Release 17 3GPP architecture, the NWDAFs 410, 412 (defined in 3GPP Technical Specification 23.288 v17.2.0) provide analytic output to one or more of the Analytics Consumer NFs 430, 432, and 434 based on data collected from one or more Data Producer NFs 420, 422 and 424. At least part of the collected data may be collected via the DCCF 440. The analytic output may be derived by the NWDAFs 410, 412 using a trained ML model.

As part of Release 18 work one objective is to improve the analytics accuracy of NWDAF. The analytics accuracy using a trained ML Model may deteriorate in time. One cause of such scenario is the case of an ML Model Drift. ML models are trained using data collected from one or more network function, AF and OAM. With time the data collected may become inaccurate or invalid over time which results in a “drift” in the accuracy of the analytics using such collected data. By way of example, a cause of such drift may be when a network operator changes the resources for a network function that acts as a data source for the analytics. Due to this drift, the model may be periodically unstable and the predictions provided therefrom may be accurate initially but become erroneous with time, i.e. after some time has elapsed.

Solutions have been disclosed in 3GPP TR 23.700-81 to allow an NWDAF (either AnLF or MTLF) to determine the accuracy of the ML model or the analytics predictions. Some solutions propose the MTLF determines the accuracy of the ML Model by comparing historical data with prediction and ground truth data (where ground truth is the real-time data). Some solutions propose the AnLF determines the accuracy of the analytics prediction by comparing the prediction with ground truth data. Some solutions propose the analytics consumer provides feedback information on analytics accuracy to the AnLF or MTLF. One solution proposes the analytics consumer provides an indication that an action made will have a significant impact on the network (which will be a trigger for the NWDAF to start monitoring the accuracy of the analytic prediction). Another solution proposes measuring the impact of the decision of a NF that uses predicted outputs of an Analytic ID. The impact can be calculated according to the change of relevant KPIs of the NF, after the enforcement of a decision based on a predicted output of an Analytic ID. In particular, the impact may be characterized by an Analytics ID grade information, e.g., a real number between [−1, 1]. In case the grade information is below a limit a cooling duration related to the used of an Analytics ID is introduced to pause erroneous and/or unstable decisions and allow time to refresh the output. Finally, some solutions propose the NWDAF rates the data sources by evaluating the quality of the data. If the NWDAF determines that the data source does not provide accurate data then the NWDAF may discard the data from the data source.

PCT/EP2022/062706 (SMM920210250-WO-PCT) is an international patent application that describes a method where the MTLF determines ML model drift by taking into account feedback information received from an analytics consumer. The feedback information may include the impacted NFs. The MTLF uses this information to determine if there is an ML Model drift if the NF ID corresponds to a data producer NF.

PCT/EP2022/075414 (SMM920220076-WO-PCT) is an international patent application that describes a method to rate data sources for ensuring analytics correctness and a solution to detect and improve the correctness of NWDAF analytics by enabling a rating of the data sources, i.e., profiles/reputation. Such rating can be based on (i) local estimation/calculation between the predicted and ground-truth data, (ii) analytics consumer feedback, or (iii) provided by an AF in the forms of weights. This solution is particularly applicable for analytics which take inputs from UEs (via AF) or from AF which cannot be as trusted data sources as the OAM and NFs internal to the wireless communication network.

Consumer feedback may be based on the performance of analytics and may serve as a trigger for data source investigation and rating by NWDAF, which may collect supplementary data to do so if that is possible. The data source investigation may result in altering the confidence degree of a subsequent prediction made using the same analytic.

There is provided herein a solution that provides information on possible feedback that an analytics consumer can provide and the possible actions that may be performed by an NWDAF AnLF and/or NWDAF MTLF upon receiving said feedback. Different from other approaches, an aim of the one introduced herein, is to identify the data sources affected from erroneous or unstable AnLF analytics and limit their effect on future analytics output by controlling their impact on AnLF and MTLF. Such control may be facilitated by rating the data sources used by the erroneous or unstable AnLF analytics.

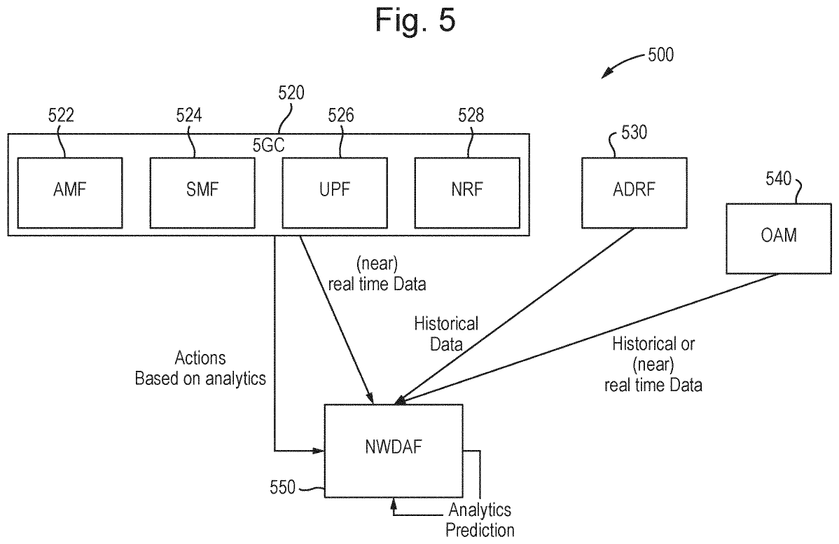

The data analytics function described herein, which may be an NWDAF, may determine the accuracy of an analytics prediction by comparing historical data collected from the Analytics Data Repository Function “ADRF” or other data sources, ground truth data and comparing the result with analytics prediction based on the architecture illustrated in FIG. 5. FIG. 5 illustrates a wireless communication system 500 comprising a 5G core 520, an ADRF 530, an OAM 540, and an NWDAF 550. The 5G Core 520 comprises an Access and Mobility Management Function (AMF) 522, a Session Management Function (SMF) 524, a User Plane Function (UPF) 526, and a Network Repository Function (NRF) 528. In operation, the NWDAF 550 receives data from any of the 5G core, the ADRF 530, and the OAM 540. The NWDAF 550 performs analysis in the received data. The analysis may comprise a particular analytics operation.

An analytics consumer may provide as analytics feedback the following information: NF identity (NF ID) of NFs impacted by an action, an area impacted by the action, and/or the identities of any Management Service Producers (MnS Producers) impacted by the action.

If the consumer is the PCF, then an example of a NF impacted by the action may comprise the NF ID of the SMF where PCC rules including updated QoS rules are provided. Alternatively, if the consumer is the SMF, then the NF impacted by the action may comprise the NF ID of the UPF where traffic was routed (e.g. when the SMF makes decision to relocate a UPF). If consumer is the AF, then an NF impacted by the action may comprise the DNAI where traffic of one or more UEs will be routed. If a consumer is the NSSF, then an NF impacted by the action may comprise a new slice instantiated. If the consumer is the NSSF or AMF, then an NF impacted by the action may comprise refresh decisions related to an existing, ongoing slice.

The area impacted may be based on network topology, Traffic Area and/or Geographical area.

If a consumer is the MDA MnS Producer analytics type (e.g., Network slice load or fault management, or Service Experience, etc.), then an impacted MnS Producer ID may comprise the identifier of the MFs, the slice identifier, etc. If the consumer is an orchestrator, e.g., Communication Service Management Function (CSMF) and/or Network Slice Management Function (NSMF), and/or Network Slice Subnet Management Function (NSSMF) or any other orchestrator not limited on supporting the slicing capability (e.g., edge computing), then an impacted MnS Producer ID may comprise the impacted managed objects, i.e., managed entities, sub-networks, etc.

When the NWDAF receives the feedback information the NWDAF can take the following actions:
Start rating the data sources by comparing data collecting in the past (from the ADRF) with new data.
Discard historical data from the Network Functions/Service Area indicated in the feedback information when data from these NFs are used for inference or model training.
Correlate the performance measurements of the affected data sources with the performance impact on future Analytics IDs and introduce a weight to control their impact for inference or model training.
Notify other AnLF Analytics IDs that operate in the same target area about data sources affected negatively from erroneous predictions.
Estimate the duration of the time duration related to the impact of an erroneous AnLF prediction.
Estimate the amount of new data, i.e., data volume, needed to restore the impact of an unreliable AnLF prediction and/or in relation with the time that an AnLF needs to collect new data from affected data sources.

Notifying other AnLF Analytics IDs that operate in the same target area about data sources affected negatively from erroneous predictions may be: executed directly among AnLFs in the same target area with the assistance of NRF that allows an AnLF to identify other AnLFs in the same area; in this way since a certain AnLf would not know the exact data sources used by other AnLFs it may inform all, i.e., brute force manner; or handled via the corresponding MTLF(s) that operate in the same target area with the assistance of NRF that allows an AnLF to identify other AnLFs in the same area; using MTLFs may reduce the signalling cost for certain deployment scenarios since the MTLF has knowledge regarding the data source(s) used by specific AnLFs; or a means to introduce a pause or cooling duration for data sources affected by erroneous predictions.

Estimating the duration of the time duration related to the impact of an erroneous AnLF prediction may be: the time duration related to the prediction, e.g., when an SMF selects a sub-optimal UPF since it received wrong information related to the expected load; or an estimated time (longer than the time duration of the erroneous prediction) that introduces a domino effect relate to the performance degradation impact of a prediction to a network region or slice, and which can be estimated encountering the plethora of network objects involved and their inter-relation.

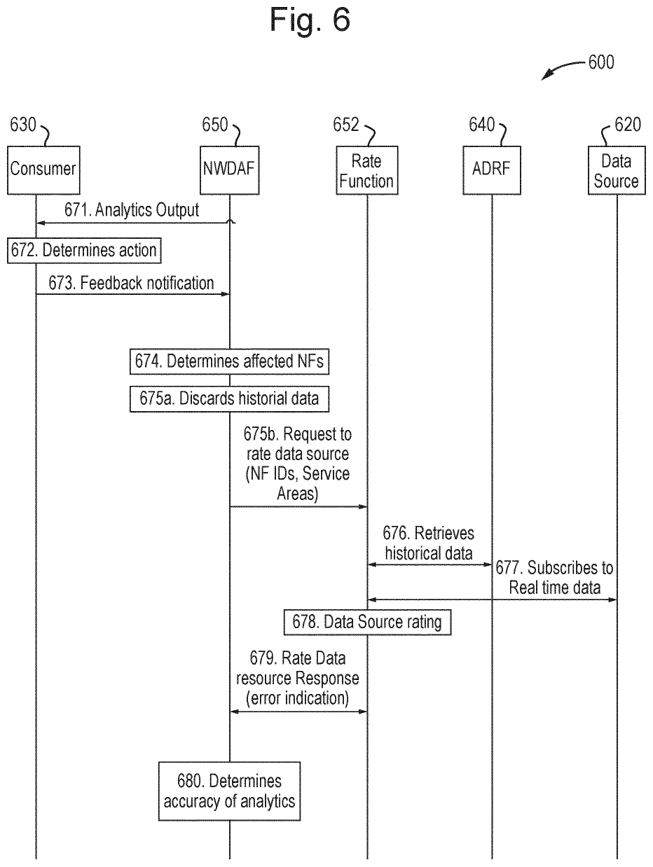

FIG. 6 illustrates a method 600 that may be performed by a data analytics function as described herein. The data analytics function may comprise an NWDAF. The data analytics function utilizes analytics feedback information for improving analytics prediction accuracy. The method 600 is performed between a consumer 630, an NWDAF 650, a rate function 652, an ADRF 640 and a data source 620. By way of example, data source 620 may comprise a 5G core Network Function, an OAM, and/or an Application Function. The function of the ADRF 640 described in this example may instead be performed by an OAM.

At 671, the NWDAF 650 provides requested analytics to the consumer 630.

At 672, the consumer 630 determines an action based on the received analytics. For example, if the analytics indicate a high load at a UPF function the consumer, (in such a case the SMF) may select a less loaded UPF.

At 673, the consumer 630 sends a feedback notification to the NWDAF 650. The feedback notification may comprise NF IDs and/or a service area. The consumer 630 reports the action taken to the NWDAF 650. An example of an action is the consumer 630 to report the UPF selected and the load of the selected UPF.

At 674, the NWDAF 650 determine all the affected NFs based on the feedback information provided by the analytics consumer 630.

For example, if the consumer 630 included an NF ID of an SMF, the NWDAF 650 determines the UPFs served by this SMF by retrieving the information from the UDM (not illustrated). By way of further example, if the consumer 650 included a list of UEs, the NWDAF 650 determines the NFs serving the listed UEs

The NWDAF 650 may determine if the NFs affected are used as data sources for model training or analytics inference by referring to one or more analytic IDs.

In a first alternative, at 675a, the NWDAF 650 may decide to discard data when the NFs determines in step 674 are used as data sources in analytics inference or model training.

In a second alternative, at 675b, the NWDAF may decide to rate the data source by sending a request to the rate function 652. Based on this rating, a weight may be introduced to each affected source to limit its impact on future analytics output. The rating request may comprise NF IDs and/or a service area. The rate function 652 may be collocated with the NWDAF 650.

At 676, the rate function 652, which may be within the NWDAF 650, retrieves historical data from the ADRF 640. At 677, the rate function 652 subscribes to real time data from the data source 620. At 678, the rate function 652 rates the data source by comparing historical data with real time data. Real time data may comprise current data received from a data source. Real time data from a data source may comprise the data most recently received from the data source.

At 679, the rate function 652, which may be within the NWDAF 650, provides information on the rate of the data source. In one embodiment the information can be an error indication indicating a “data drift” from historical data. The “data drift” may comprise a discrepancy between a trend predicted from the historical data and the real time data.

At 680, the NWDAF 650 uses the information to determine if analytics accuracy is affected. The NWDAF 650 may decide to re-train an ML model or adjust its analytics prediction accuracy based on the error reported.

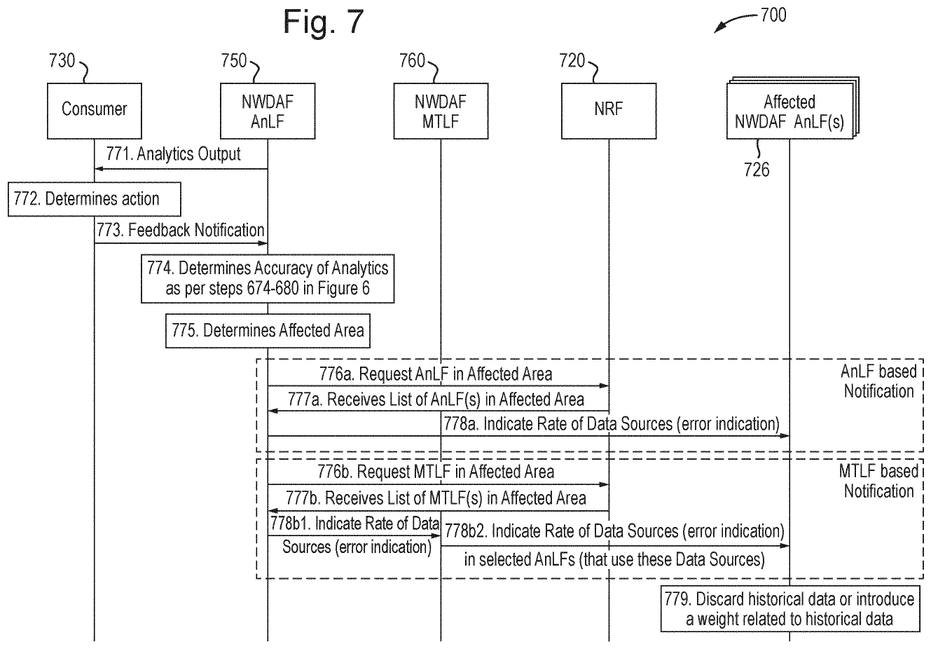

FIG. 7 illustrates a procedure 700 for informing any other potentially affected AnLF(s) that operate in the same area as data analytics function. The procedure 700 take place in a system comprising an analytics consumer 730, a data analytics function comprising an NWDAF AnLF 750, an NWDAF MTLF 760, an NRF 720 and at least one NWDAF AnLF in an affected area 726. The procedure 700 considers two different variations: (i) ‘AnLF based Notification’, where the NWDAF AnLF 750 directly informs other potentially affected AnLF(s) 726, and (ii) ‘MTLF based Notification’, where the NWDAF AnLF 750 informs the corresponding NWDAF MTLF(s) 760 that in turn inform selected NWDAF AnLF(s) 726 that utilize the same erroneous data sources.

At 771, the NWDAF AnLF 750 provides requested analytics to the consumer 730.

At 772, the consumer 730 may determine an action based on the received analytics as described above (in connection with FIG. 6).

At 773, the consumer 730 reports the action taken to the NWDAF AnLF 750 as described above (in connection with FIG. 6).

At 774, the NWDAF AnLF 750 determines the accuracy of analytics in accordance with steps 674 to 680 described above in connection with FIG. 6.

At 775, the NWDAF AnLF 750 optionally determines the affected geographical area considering the erroneous data sources. If the AnLF cannot determine the affected geographical area it can use the IP address of the erroneous data source(s) and send a request to the NRF 720.

In a first of two alternatives, option (i) ‘AnLF based Notification’, the NWDAF AnLF 750 directly contacts other potentially affected AnLFs to inform them about erroneous data sources.

At 776a, the NWDAF AnLF 750 requests the NRF 720 about other NWDAF AnLFs 726 that operate in the geographical area that contains the erroneous data source(s).

At 777a, the NWDAF AnLF 750 receives the list of potentially affected AnLF(s) that operate in the indicated geographical area.

At 778a, the NWDAF AnLF 750 can then inform the other NWDAF AnLFs 726 by sending a message listing the erroneous data sources including a related rating and/or a suggested weight. The NWDAF AnLF 750 can identify other affected NWDAF AnLF(s) 726 based on the associated Analytics ID (since an Analytics ID has a pre-determined list of input data sources). Otherwise, if that is not possible, the NWDAF AnLF 750 informs all AnLFs, in the wireless communication network, i.e., in a brute force manner.

In a second of two alternative options, option (ii) ‘MTLF based Notification’, the NWDAF AnLF 750 indirectly contacts other potentially affected NWDAF AnLFs 726 to inform them about erroneous data sources by notifying the corresponding NWDAF MTLFs.

At 776b, the NWDAF AnLF 750 sends a request to the NRF 720 for the identity of the corresponding MTLF(s) that operate in the geographical area that contains the erroneous data sources.

At 777b, the NWDAF AnLF 750 receives the list of potentially affected MTLF(s) that operate in the indicated geographical area.

At 778b1, the NWDAF AnLF 750 informs the listed MTLF(s) by sending a message that list the erroneous data sources including a related rating and/or a suggested weight. The NWDAF AnLF 750 may determine the affected MTLF(s) based on the associated Analytics ID (since an Analytics ID has a pre-determined list of input data sources). Otherwise, if this is not possible, it informs all MTLF(s) in the wireless communication network (this may be considered a brute force approach).

At 778b2, the NWDAF MTLF 760 informs the affected NWDAF AnLFs 726 by sending a message that lists the erroneous data sources including the indicated rating and/or a suggested weight. The NWDAF MTLF 760 may determine the affected NWDAF AnLF(s) 726 based on the training provided considering the list of input data sources.

After either of option (i) or (ii), at 779, the NWDAF AnLF 750 may decide to discard the data and/or employ a weight to limit the impact from the indicated data sources.

In an alternative, when the NWDAF AnLF 750 receives feedback information the NWDAF AnLF 750 may indicate to the NWDAF MTLF 760 where the NWDAF AnLF 750 has obtained trained models, the affected NFs. The NWDAF MTLF 760 uses this information to determine ML model accuracy if the NWDAF MTLF 760 used data to train the ML models from the affected NFs.

In another alternative when the NWDAF AnLF 750 receives feedback information, and the NWDAF AnLF 750 has rated the data sources according to the feedback information the NWDAF AnLF 750 may indicate to the NWDAF MTLF 760 where the NWDAF AnLF 750 has obtained trained models, and the rating of the NFs. The NWDAF MTLF 760 uses this information to determine ML model accuracy if the NWDAF MTLF 760 used data to train the ML models from these NFs.

Accordingly, there is provided a data analytics function comprising a receiver and a processor. The receiver is arranged to receive analytics feedback information in respective of particular analytics from an analytics consumer. The processor is arranged to: identify affected network functions based on the analytics feedback information; determine if the affected network functions are used as data sources for the particular analytics; rate the network functions as data sources by comparing a prediction with source data; and determine the accuracy of the particular analytics based on the rating of the network functions used as a source of data for the particular analytics.

Rating the network functions as defined herein allows a data analytics function to accommodate changes in the wireless communication network, and so compensate for the ‘model drift’that is found to adversely affect analytics accuracy over time.

The analytics may comprise: model training, analytics inference, and/or a trained machine learning model. The source data may comprise data received from sources. The source data may comprise ground truth data. The source data may comprise historical data, and/or real-time data. The data analytics function may comprise an NWDAF or an AnLF NWDAF. Identifying affected network functions based on the analytics feedback information may comprise identifying an affected service area and then identifying the affected network functions as the network functions serving the affected service area.

The analytics feedback information may include a network function identity, and the processor may be further arranged to identify affected network functions as the network function having that network function identity, and/or the network functions served by the network function having that network function identity.

The analytics feedback information may comprise an affected service area of a wireless communication network.

The processor may be further arranged to identify affected network functions by sending a request for information concerning network functions served by and/or serving an affected network function. For example, the data analytics function may identity affected network functions by sending information of impacted network functions to a UDM and receiving in response the network functions serving the impacted network functions.

Where the analytics feedback information includes a service area, then the processor may identify affected network functions as the network functions serving the indicated service area.

The processor may identify affected network functions by sending a request for information concerning network functions served by and/or serving the indicated service area.

The processor may be further arranged to rate the network functions as data sources by comparing a prediction derived from the particular analytics with source data. The processor may rate the network functions as data sources by comparing historical data with source data. The source data may comprise real-time data.

The processor may be further arranged to discard data received from the affected network functions for analytics inference or training a machine learning model based on the rating of the affected network functions.

The processor may be further arranged to provide a rating of the network functions as data sources. The rating may be provided as an error indication. The error indication may comprise a reported error. The error indication may indicate a data drift. The data drift may comprise a departure from a trend set by historical data.

The particular analytics may comprise a machine learning model and the processor may be further arranged to determine that a network function is used as a data source for training the machine learning model is affected based on the rating of the affected network function, and the processor may be further arranged to re-train the machine learning model by collecting new data from the affected network functions.

The particular analytics may comprise a machine learning model and the processor may be further arranged to determine that a network function used as a data source for the machine learning model or inference is affected based on a rating of the network function, the processor may be further arranged to adjust an analytics prediction accuracy based on a reported rating. An NWDAF may be an AnLF that provides analytics inference using a machine learning model and data from a data source, or an MTLF that trains a machine learning model based on data from the data sources.

The rating may comprise an error percentage indicating a data distribution drift. The rating may comprise an error percentage indicating a degree of data distribution drift.

The data analytics function may further comprise a transmitter arranged to indicate to other data analytics function the rated data sources.

The data analytics function may further comprise a transmitter. The transmitter may be arranged to send a request to a Network Repository Function for the identity of other data analytics functions that operate in the geographical area that contains the affected data sources and rating information. The receiver may be further arranged to receive a list of potentially affected data analytics functions. The transmitter may be further arranged to send a message to the potentially affected data analytics functions, the message indicating the affected network functions and including a rating of the affected network functions.

Alternatively, the data analytics function may send a message to all other data analytics functions in a wireless communication network, the message indicating the affected network functions and including a rating of the affected network functions.

The other data analytics functions that operate in the geographical area may comprise NWDAF Analytics Logical Functions (ANLFs) or NWDAF Model Training Logical Functions (MTLFs). Where the data analytics function sends the message to a NWDAF Model Training Logical Function (MTLF), the NWDAF Model Training Logical Function (MTLF) may forward the message to associated NWDAF Analytics Logical Functions (ANLFs)

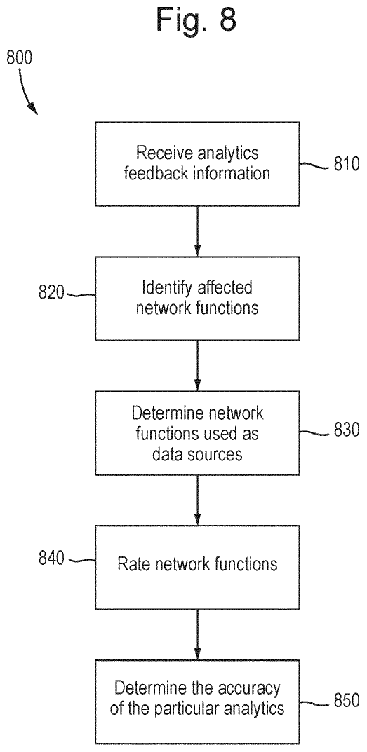

FIG. 8 illustrates a method 800 in a data analytics function. The method 800 comprises: receiving 810 analytics feedback information in respective of particular analytics, the analytics feedback information received from an analytics consumer; and identifying 820 affected network functions based on the analytics feedback information. The method 800 further comprises: determining 830 if the affected network functions are used as data sources for the particular analytics; rating 840 the network functions as data sources by comparing a prediction with source data; and determining 850 the accuracy of the particular analytics based on the rating of the network functions used as a source of data for the particular analytics.

In certain embodiments, the method 800 may be performed by a processor executing program code, for example, a microcontroller, a microprocessor, a CPU, a GPU, an auxiliary processing unit, a FPGA, or the like.

Rating the network functions as defined herein allows a data analytics function to accommodate changes in the wireless communication network, and so compensate for the ‘model drift’that is found to adversely affect analytics accuracy over time.

The analytics may comprise: model training, analytics inference, and/or a trained machine learning model. The source data may comprise data received from sources. The source data may comprise ground truth data. The source data may comprise historical data, and/or real-time data. The data analytics function may comprise an NWDAF or an AnLF NWDAF. Identifying affected network functions based on the analytics feedback information may comprise identifying an affected service area and then identifying the affected network functions as the network functions serving the affected service area.

The analytics feedback information may include a network function identity, and the method may further comprise identifying affected network functions as the network function having that network function identity, and/or the network functions served by the network function having that network function identity. The analytics feedback information may comprise an affected service area of a wireless communication network.

Identifying affected network functions may comprise sending a request for information concerning network functions served by and/or serving an affected network function. For example, the data analytics function may identity affected network functions by sending information of impacted network functions to a UDM and receiving in response the network functions serving the impacted network functions.

The analytics feedback information may include a service area, and the method further comprises identifying affected network functions as the network functions serving the indicated service area.

Identifying affected network functions may comprise sending a request for information concerning network functions served by and/or serving the indicated service area.

The method may further comprise rating the network functions as data sources by comparing a prediction derived from the particular analytics with source data. Rating the network functions as data sources may comprise comparing historical data with source data. The source data may comprise real-time data. The method may further comprise discarding data received from the affected network functions for analytics inference or training a machine learning model based on the rating of the affected network functions.

The method may further comprise providing a rating of the network functions as data sources. The rating may be provided as an error indication. The error indication may comprise a reported error. The error indication may indicate a data drift. The data drift may comprise a departure from a trend set by historical data.

The particular analytics may comprise a machine learning model and the method may further comprise determining that a network function is used as a data source for training the machine learning model is affected based on the rating of the affected network function, and re-training the machine learning model by collecting new data from the affected network functions.

The particular analytics may comprise a machine learning model and the method may further comprise determining that a network function used as a data source for the machine learning model or inference is affected based on a rating of the network function, and adjusting an analytics prediction accuracy based on a reported rating. An NWDAF may be an AnLF that provides analytics inference using a machine learning model and data from a data source, or an MTLF that trains a machine learning model based on data from the data sources.

The rating may comprise an error percentage indicating a data distribution drift. The rating may comprise an error percentage indicating a degree of data distribution drift.

The method may further comprise indicating to other data analytics function the rated data sources.

The method may further comprise: sending a request to a Network Repository Function for the identity of other data analytics functions that operate in the geographical area that contains the affected data sources and rating information; receiving a list of potentially affected data analytics functions; and sending a message to the potentially affected data analytics functions, the message indicating the affected network functions and including a rating of the affected network functions.

Alternatively, the data analytics function may send a message to all other data analytics functions in a wireless communication network, the message indicating the affected network functions and including a rating of the affected network functions.

The other data analytics functions that operate in the geographical area may comprise NWDAF Analytics Logical Functions (ANLFs) or NWDAF Model Training Logical Functions (MTLFs). Where the data analytics function sends the message to a NWDAF Model Training Logical Function (MTLF), the NWDAF Model Training Logical Function (MTLF) may forward the message to associated NWDAF Analytics Logical Functions (ANLFs).

As part of Release 18 work one objective is to improve the analytics accuracy of NWDAF. An issue with existing analytics is that analytics accuracy using a trained ML Model may deteriorate in time. One cause of such scenario is the case of an ML Model Drift. ML models are trained using data collected from one or more network function. With time the data collected becomes inaccurate or invalid (e.g. when network operator changes the resources for a network function) which result in a “drift” in the accuracy of the analytics using such model. Due to this drift, the model keeps becoming unstable and the predictions keep on becoming erroneous with time.

There is provided herein a solution whereby the NWDAF determines if an action taken by an analytics consumer has affected the NFs used as data sources for analytics generation or model training. The NWDAF uses the feedback provided by the analytics consumer to determine the affected NFs. The NWDAF then starts rating the NFs to determine if their data distribution has changed which may affect the accuracy of the ML model and/or analytics. If the NWDAF determines that an NF is affected the NWDAF may introduce weights to control their impact for inference or model training.

Solutions have been disclosed in 3GPP TR 23.700-81 to allow the NWDAF (either AnLF or MTLF) to determine the accuracy of the ML model or the analytics predictions.
Some solutions propose the MTLF to determine the accuracy of the ML Model by comparing historical data with prediction and ground truth data (where ground truth is actually the real-time data).
Some solutions propose the AnLF to determine the accuracy of the analytics prediction by comparing the prediction with ground truth data.
Some solutions propose the analytics consumer to provide feedback information on analytics accuracy to the AnLF or MTLF. One solution proposes (solution proposed by Lenovo) the analytics consumer to provide an indication that an action made will have significant impact on the network (which will be a trigger for the NWDAF to start monitoring the accuracy of the analytic prediction).
Finally, some solutions propose the NWDAF to rate the data sources by evaluating the quality of the data. If the NWDAF determines that the data source do not provide accurate data then the NWDAF may discard the data from the data source

According to the present disclosure, the NWDAF may use the analytic feedback information from a consumer to trigger data source rating. The NWDAF may use feedback information to trigger data source rating. Further, the AnLF may notify other AnLF/MTLF of the affected NFs based on the consumer feedback.

Accordingly, there is provided an NWDAF receiving from an analytics consumer analytics feedback information and that: determines the affected NFs based on the analytics feedback information; determines if the affected NFs are used as data sources for model training or analytics inference; rates the data sources by comparing historical data with ground truth data; and determines the accuracy of an analytics/trained ML model based on the rating of the data source.

The feedback information may include an affected service area of the network.

The feedback information may include affected Network Functions from the action taken.

The NWDAF may determine the affected NFs by sending to an NF (UDM) information of the impacted NFs and receive in response the NFs serving the impacted NFs.

The NWDAF may indicate to other analytics NFs the rated data sources.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: CSMF, Communication Service Management Function; ML, Machine Learning; NF, Network Function; NWDAF, Network Data Analytics Function; NRF, Network Repository Function; NSMF, Network Slice Management Function; NSSMF, Network Slice Subnet Management Function; OAM, Operations and Maintenance; UE, User Equipment; MTLF, Model Training Logical Function; and AnLF, Analytics Inference Logical Function.

1. A data analytics function for wireless communication, comprising:
at least one memory; and
at least one processor coupled with the at least one memory and configured to cause the data analytics function to:
receive, from an analytics consumer, analytics feedback information of analytics;
identify affected network functions based on the analytics feedback information;
determine if the affected network functions are used as data sources for the analytics;
rate the network functions as the data sources by comparing a prediction with source data; and
determine an accuracy of the analytics based on a rating of the network functions used as the data sources for the analytics.

2-3. (canceled)

4. The data analytics function of claim 1, wherein when the analytics feedback information includes an indicated service area, and the at least one processor is configured to cause the data analytics function to identify affected network functions as the network functions serving the indicated service area.

5. The data analytics function of claim 4, wherein, to identify the affected network functions, the at least one processor is configured to cause the data analytics function to send a request for information associated with one or more of the network functions served by or serving the indicated service area.

6. The data analytics function of claim 1, wherein the at least one processor is configured to cause the data analytics function to rate the network functions as the data sources by comparing the source data with a prediction derived from the analytics.

7. The data analytics function of claim 1, wherein the at least one processor is configured to cause the data analytics function to discard data received from the affected network functions for analytics inference or training a machine learning model based on a rating of the affected network functions.

8. The data analytics function of claim 1, wherein the at least one processor is configured to cause the data analytics function to provide the rating of the network functions as the data sources.

9. (canceled)

10. The data analytics function of claim 1, wherein the analytics comprise a machine learning model and the at least one processor is configured to cause the data analytics function to:
determine that a network function used as a data source for the machine learning model is affected based on the rating of the network function; and
adjust an analytics prediction accuracy based on a reported rating.

11. The data analytics function of claim 10, wherein the rating comprises an error percentage indicating a data distribution drift.

13-14. (canceled)

15. A method performed by a data analytics function, the method comprising:
receiving, from an analytics consumer, analytics feedback information of analytics;
identifying affected network functions based on the analytics feedback information;
determining if the affected network functions are used as data sources for the analytics;
rating the network functions as the data sources by comparing a prediction with source data; and
determining an accuracy of the analytics based on a rating of the network functions used as the data sources for the analytics.

16-17. (canceled)

18. The method of claim 15, wherein the analytics feedback information includes an indicated service area, and the method further comprises identifying affected network functions as the network functions serving the indicated service area.

19. The method of claim 18, wherein identifying the affected network functions comprises sending a request for information associated with one or more of the network functions served by or serving the indicated service area.

20. The method of claim 15, further comprising rating the network functions as the data sources by comparing the source data with a prediction derived from the analytics.

21. The method of claim 15, further comprising:
discarding data received from the affected network functions for analytics inference or training a machine learning model based on a rating of the affected network functions.

22. The method of claim 15, further comprising:
providing the rating of the network functions as the data sources.

23. The method of claim 15, wherein the analytics comprise a machine learning model; and the method further comprising:
determining that a network function used as a data source for the machine learning model is affected based on the rating of the network function; and
adjusting an analytics prediction accuracy based on a reported rating.

24. A network node for wireless communication, comprising:
at least one memory; and
at least one processor coupled with the at least one memory and configured to cause the network node to:
receive, from an analytics consumer, analytics feedback information of analytics;
identify affected network functions based on the analytics feedback information;
determine if the affected network functions are used as data sources for the analytics;
rate the network functions as the data sources by comparison of a prediction with source data; and
determine an accuracy of the analytics based on a rating of the network functions used as the data sources for the analytics.

25. The network node of claim 24, wherein the analytics feedback information includes an indicated service area, and the at least one processor is configured to cause the network node to identify affected network functions as the network functions serving the indicated service area.

26. The network node of claim 25, wherein, to identify the affected network functions, the at least one processor is configured to cause the network node to send a request for information associated with one or more of the network functions served by or serving the indicated service area.

27. The network node of claim 24, wherein the at least one processor is configured to cause the network node to rate the network functions as the data sources by comparison of the source data with a prediction derived from the analytics.

28. A method performed by a network node, the method comprising:
receiving, from an analytics consumer, analytics feedback information of analytics;
identifying affected network functions based on the analytics feedback information;
determining if the affected network functions are used as data sources for the analytics;
rating the network functions as the data sources by comparison of a prediction with source data; and
determining an accuracy of the analytics based on a rating of the network functions used as the data sources for the analytics.
